(19) United States
(12) Patent Application Publication
(10) Pub. No.: US 2012/0099555 A1
(43) Pub. Date: Apr. 26, 2012

(54) TERMINAL APPARATUS, BASE STATION APPARATUS, FEEDBACK METHOD AND RETRANSMISSION CONTROL METHOD

(75) Inventors: Isamu Yoshii, Kanagawa (JP); Takaaki Kishigami, Tokyo (JP); Kenichi Kuri, Kanagawa (JP)

(73) Assignee: PANASONIC CORPORATION, Osaka (JP)

(21) Appl. No.: 13/380,354

(22) PCT Filed: Jul. 9, 2010
(86) PCT No.: PCT/JP2010/004483

§ 371 Date: Dec. 22, 2011

(30) Foreign Application Priority Data
Jul. 10, 2009 (JP) 2009-163396

(51) Int. Cl. H04W 72/04

(52) U.S. Cl. 370/329

(57) ABSTRACT

Disclosed are a terminal apparatus and a base station apparatus wherein the collision of the response signals of a plurality of terminals can be avoided. A response control unit (207) performs a control such that a data response resource, which is notified by downstream assignment control information, is used to transmit an ACK/NACK responsive to a downstream data error detection result. When a PA determining unit (204) determines that PA has terminated, the response control unit (207) performs a control such that the same resource as the data response resource is used to transmit an ACK as a response signal responsive to the downstream assignment control information. When having received the ACK responsive to the downstream assignment control information at the termination of PA, a retransmission control unit (106) determines that the termination of PA has completed. When having received a NACK responsive to the downstream data at the termination of PA, the retransmission control unit (106) determines that the resource assignment termination has been overlooked. When having determined that the termination of PA has been overlooked, the retransmission control unit (106) performs a control such that the downstream assignment control information transmitted at the termination of PA is retransmitted.

### TECHNICAL FIELD

The present invention relates to a terminal apparatus, a base station apparatus, a feedback method, and a retransmission control method.

### BACKGROUND ART

In recent years, services of mobile WiMAX have been deployed worldwide using a frequency band centered at 2.5 GHz. In addition, the IEEE rushes into a standardization of IEEE 802.16m to be a specification of the next-generation mobile WiMAX to propose an International Mobile Telecommunication Advanced (IMT-Advanced) candidate technology with it (refer to Non-Patent Literature 1).

In accordance with IEEE 802.16m, a base station apparatus (hereinafter, referred to as “base station”) periodically allocates the same resource to a terminal apparatus (hereinafter, referred to as “terminal”). This allocation method is called Persistent Allocation (PA). The Persistent Allocation (PA) will now be described with reference to FIG. 1.

FIG. 1 illustrates resources allocated to downlink (DL) and Uplink (UL) in a case of employing the persistent allocation (PA).

In the DL of FIG. 1, the “PA Advanced MAP (A-MAP)” allocated to Frame 0 is a downlink allocation control channel for allocating downlink allocation control information of the persistent allocation (PA). A base station notifies the PA allocation target terminal of the PA initiation (resource allocation initiation) instruction using PA A-MAP. In the DL of FIG. 1, “Data” allocated to Frame 0 is a downlink data channel. In the example of FIG. 1, the downlink data channel is periodically allocated with a period of 2 frames.

The aforementioned downlink allocation control channel (PA A-MAP) is notified to the terminal from the base station at the event of “PA initiation (PA),” “PA allocation change (PA deallocation),” and “PA termination (PA release).” FIG. 1 illustrates an example in which the base station transmits PA A-MAP for instructing “PA initiation” to the terminal in Frame 0 and transmits PA A-MAP for instructing “PA allocation change” in Frame 4.

PA A-MAP transmitted at the event of “PA initiation” contains information concerning a period of the downlink resource for allocating the downlink data channel, a position of the downlink resource, an Acknowledgment/Negative Acknowledgment (ACK/NACK) resource for the downlink data (hereinafter, referred to as “data response resource”), and the like. The terminal receives the downlink data based on information concerning the period and the position of the downlink resource contained in PA A-MAP and transmits ACK/NACK with respect to the received downlink data using the data response resource.

HARQ feedback allocation (HFA) may be used as information indicating the data response resource. HFA indicates the resource number of the data response resource. In addition, a channel through which ACK/NACK for the downlink data and the downlink allocation control information are transmitted is called HARQ feedback channel (HFBCH). In addition, HFBCH includes six channels per unit. Since HFA is composed of 4 bits, it is possible to specify the resource number for two units of HFBCH by means of HFA. FIG. 2 illustrates an example of the mapping between HFA and HFBCH.

For example, as illustrated in FIG. 1, if a base station transmits HFA=0 in the Frame 0 at the event of “PA initiation,” a terminal transmits ACK/NACK for the downlink data using HFBCH_A-0 (refer to FIG. 2) corresponding to HFA=0.

PA A-MAP which notifies the “PA allocation change” instruction contains information regarding a change instruction of the allocation space and the ACK/NACK resource (hereinafter, referred to as “control response resource”) for downlink allocation control information. The allocation space change instruction includes information concerning the resource size and the position of the downlink data resource after the change. In addition, similar to the data response resource, HFA may be used as information indicating the control response resource.

The terminal receives the downlink data of which allocation is changed to this resource based on the resource size and the position of the downlink data resource instructed by the allocation space change instruction. The terminal transmits ACK/NACK for the received downlink data with use of a data response resource and transmits ACK/NACK for downlink allocation control information with use of the control response resource.

Specifically, as illustrated in FIG. 1, if a base station transmits HFA=1 in Frame 4 at the event of “PA allocation change,” the terminal transmits ACK/NACK for the downlink allocation control information with use of HFBCH_A-1 (refer to FIG. 2) corresponding to HFA=1. In addition, at this time, the terminal transmits ACK/NACK for the downlink data of “PA allocation change” with use of the data response resource HFBCH_A-0 for use in transmitting ACK/NACK for the downlink data of “PA initiation.”

In this manner, the terminal transmits ACK/NACK for the downlink data and ACK/NACK for the downlink allocation control channel with use of different uplink resource at the event of “PA allocation change.”

FIG. 3 illustrates a resource allocated to the downlink (DL) and the uplink (UL) at the event of “PA termination.”

PA A-MAP which notifies the “PA termination” instruction contains information concerning the allocation space change instruction, and the ACK/NACK resource (control response resource) corresponding to the downlink allocation control information. In addition, at the event of “PA termination,” the base station transmits PA A-MAP by setting the resource size of the downlink data resource to 0 in the allocation space change instruction. In other words, “PA termination” is a special case of “PA allocation change.” The terminal recognizes that “PA termination” is notified from the base station if the resource size of the downlink data resource instructed by the allocations space change instruction is 0. The terminal transmits ACK/NACK for downlink allocation control information using the control response resource.

Specifically, as illustrated in FIG. 3, if the base station transmits HFA=1 in Frame 4 at the event of “PA termination,” the terminal transmits ACK/NACK for the downlink allocation control information using HFBCH_A-1 (refer to FIG. 2) corresponding to HFA=1. In addition, at the event of “PA allocation change,” the terminal is not necessary to transmit ACK/NACK for the downlink data since there is no downlink data. In this manner, the terminal transmits only ACK/NACK for downlink allocation control information with use of the control response resource at the event of “PA termination.”

### CITATION LIST

### Non-Patent Literature

### NPL 1

“Part 16: Air Interface for Fixed and Mobile Broadband Wireless Access Systems”, 802.16m-09/0010r2 (working document) June 2008

### SUMMARY OF INVENTION

### Technical Problem

However, in a case where a certain terminal fails to receive PA A-MAP in the Frame 4 at the event of “PA termination” and overlooks “PA termination,” it may conflict with other terminals. The conflict between terminals will be described with reference to FIG. 4. In the following description, it is assumed that the base station transmits PA A-MAP which notifies the “PA termination” instruction to the terminal #1 in Frame 4 and transmits PA A-MAP which notifies the “PA initiation” instruction to the terminal #2 in Frame 4.

The terminal #1 determines that the transmission of the downlink data from the base station is performed in the downlink resource instructed by PA A-MAP at the event of “PA initiation” if the terminal #1 fails to receive PA A-MAP notified in Frame 4 at the event of “PA termination” and overlooks “PA termination.” Therefore, in reality, although the base station is not transmitting the downlink data to the terminal #1, the terminal #1 transmits NACK for the downlink data to the base station using the data response resource (HFBCH_A-0).

At this time, if PA A-MAP transmitted from the base station to the terminal #2 at the event of “PA initiation” contains information of the data response resource for instructing HFA=0, the terminal #2 transmits ACK/NACK for downlink data to the base station using HFBCH_A-0 corresponding to HFA=0.

Thus, as illustrated in FIG. 4, if the terminal #1 overlooks “PA termination,” the same data response resource (HFBCH_A-0) is used by both of the terminals #1 and #2 to transmit ACK/NACK for the data, so that a conflict occurs.

An object of the present invention is to provide a terminal apparatus, a base station apparatus, a feedback method, and a retransmission control method to avoid a conflict between the response signals of a plurality of terminals.

### Solution to Problem

According to an aspect of the present invention, there is provided a terminal apparatus including: a receiver section that receives downlink allocation control information transmitted with a downlink control resource and downlink data periodically transmitted with a downlink data resource indicated by the downlink allocation control information; an error detection section that detects a receipt error in the received downlink data; a determination section that determines whether or not resource allocation is terminated based on the received downlink allocation control information; and a response control section that controls transmission of a response signal used in retransmission control of the downlink allocation control information and the downlink data based on the error detection result obtained from the error detection section and the determination result obtained from the determination section, wherein the response control section transmits ACK/NACK depending on the error detection result using a data response resource notified by the downlink allocation control information, wherein the response control section transmits ACK as a response signal for the downlink allocation control information using the same resource as the data response resource if the determination section determines that the resource allocation is terminated.

According to another aspect of the present invention, there is provided a base station apparatus including: a transmitter section that periodically transmits downlink data using a downlink data resource at the event of resource allocation initiation, transmits downlink allocation control information containing a control response resource for transmitting ACK/NACK depending on an error result of the downlink data and information of the downlink data resource, and transmits the downlink allocation control information containing information indicating resource allocation termination at the event of resource allocation termination; a receiver section that receives ACK/NACK depending on an error result of the downlink data and ACK for the downlink allocation control information with the control response resource; a determination section that determines that the resource allocation termination is completed if the receiver section receives ACK for the downlink allocation control information at the event of resource allocation termination and determines that the resource allocation termination is overlooked if the receiver section receives NACK for the downlink data; and a control section that controls retransmission of the downlink allocation control information at the event of resource allocation termination if the determination section determines that the resource allocation termination is overlooked.

According to still another aspect of the present invention, there is provided a feedback method including: receiving downlink allocation control information transmitted with a downlink control resource and downlink data periodically transmitted with a downlink data resource indicated by the downlink allocation control information; detecting an receipt error in the received downlink data; determining whether or not resource allocation is terminated based on the received downlink allocation control information; and transmitting ACK/NACK depending on a detection result of the receipt error using the data response resource notified by the downlink allocation control information and transmitting ACK as a response signal for the downlink allocation control information using the same resource as the data response resource if it is determined that the resource allocation is terminated.

According to still further another aspect of the present invention, there is provided a retransmission control method including: periodically transmitting downlink data using a downlink data resource at the event of resource allocation initiation, transmitting downlink allocation control information containing a control response resource for transmitting ACK/NACK depending on an error result of the downlink data and information of the downlink data resource, and transmitting the downlink allocation control information containing information indicating resource allocation termination at the event of resource allocation termination; receiving ACK/NACK depending on an error result of the downlink data and ACK for the downlink allocation control information with the control response resource; determining that the resource allocation termination is completed if ACK for the downlink allocation control information is received at the event of resource allocation termination and determining that the resource allocation termination is overlooked if NACK for the downlink data is received; and performing retransmission control for the downlink allocation control information at the event of resource allocation termination if it is determined that resource allocation termination is overlooked.

### Advantageous Effects of Invention

According to the present invention, it is possible to avoid a conflict of the response signal between a plurality of terminals.

### BRIEF DESCRIPTION OF DRAWINGS

FIG. 1 is a diagram illustrating Persistent Allocation (PA);

FIG. 2 is a diagram illustrating a mapping example between HFA and HFBCH;

FIG. 3 is a diagram illustrating PA termination;

FIG. 4 is a diagram illustrating a conflict with other terminals;

FIG. 5 is a block diagram illustrating a main part configuration of a base station according to Embodiment 1 of the present invention;

FIG. 6 is a block diagram illustrating a main part configuration of a terminal according to Embodiment 1;

FIG. 7 is a diagram illustrating the operation at the event of PA termination according to Embodiment 1;

FIG. 8 is a diagram illustrating a combination of ACK/NACK/DTX for the downlink allocation control information and downlink data contemplated at the event of “PA termination”;

FIG. 9 is a diagram illustrating a decision flow in a retransmission control section;

FIG. 10 is a diagram illustrating conflict avoidance with other terminals;

FIG. 11 is a diagram illustrating a mapping example between HFA and HFBCH;

FIG. 12 is a diagram illustrating a method of notifying PA termination timings according to Embodiment 2 of the present invention;

FIG. 13 is another diagram illustrating a method of notifying PA termination timings according to Embodiment 2 of the present invention;

FIG. 14 is a diagram illustrating a mapping example between HFA and HFBCH or timings;

FIG. 15 is a diagram illustrating a mapping example between HFA and HFBCH or retransmission notification according to Embodiment 3 of the present invention;

FIG. 16 is a flow diagram illustrating the operations of a base station and a terminal according to Embodiment 3;

FIG. 17 is a diagram illustrating a case that the “PA termination” instruction is initial transmission;

FIG. 18 is a diagram illustrating a case that the “PA termination” instruction is retransmission;

FIG. 19 is a diagram illustrating a mapping example between the frequency of the leading resource of the downlink control resource and the response resource;

FIG. 20 is a diagram illustrating a case that HFA is not explicitly notified;

FIG. 21 is another diagram illustrating a case that HFA is not explicitly notified; and

FIG. 22 is still another diagram illustrating a case that HFA is not explicitly notified.

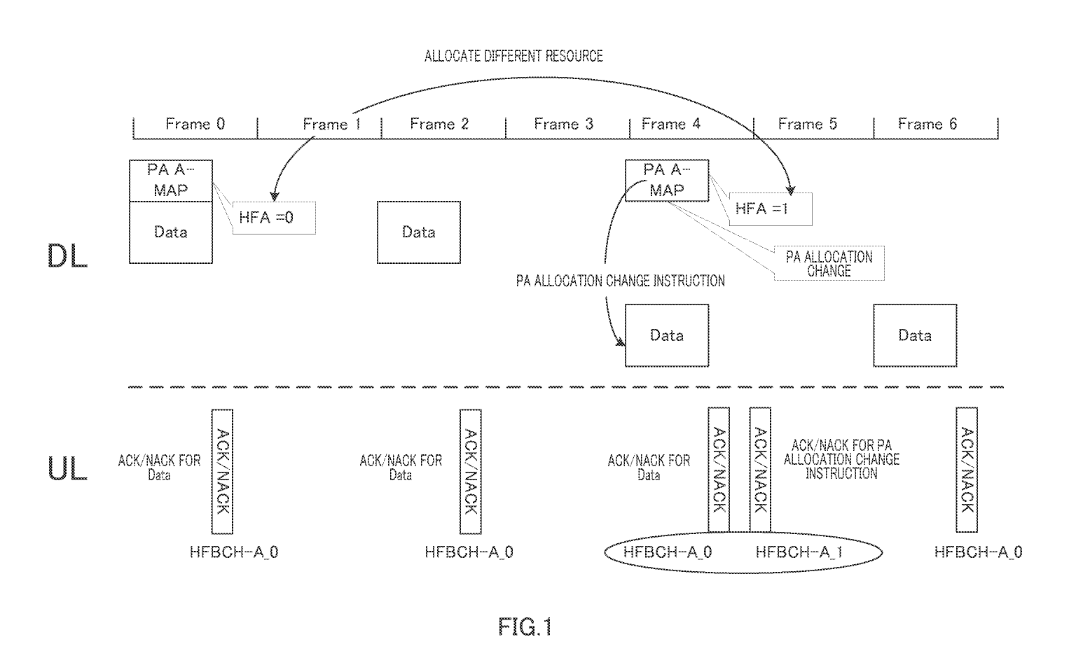

### DESCRIPTION OF EMBODIMENTS

Hereinafter, embodiments of the present invention will be described in detail with reference to the accompanying drawings.

The inventors have recognized the following fact.

[1] For the Event of “PA Allocation Change (PA Deallocation)”

Each terminal receives a downlink allocation control channel (PA A-MAP) for notifying a “PA allocation change (PA deallocation)” instruction transmitted from the base station. If the number of PA allocation target terminals is plural, in order to distinguish these terminals, the downlink allocation control information allocated to the downlink allocation control channel contains a cyclic redundancy check (CRC) bit masked by the terminal ID of the destination terminal. The terminal de-masks the CRC of the received downlink allocation control channel using the ID of the host apparatus. If the CRC result is OK, the terminal determines that the downlink allocation control information is destined to the host apparatus and transmits ACK to the base station. Otherwise, if the CRC result is NG, the terminal determines that the downlink allocation control information is not destined to the host apparatus and transmits nothing (DTX: Discontinuous Transmission).

That is, as a feedback for the downlink allocation control information at the event of “PA allocation change,” ACK or DTX is used, and it is not necessary to prepare NACK.

[2] For the Event of “PA Termination”

As the downlink allocation control channel (PA A-MAP) for notifying the “PA termination” instruction is transmitted from the base station, the downlink data are not transmitted subsequently. Therefore, the terminal does not necessarily prepare ACK as a feedback for the downlink data.

In addition, if the terminal overlooks the downlink allocation control channel (PA A-MAP), the terminal determines that it is difficult to receive the downlink data despite the downlink data is not transmitted from the base station, and transmits NACK to the base station.

If the terminal does not overlook the downlink allocation control channel (PA A-MAP) and recognizes “PA termination,” the terminal does not necessarily prepare ACK as a feedback for the downlink data because the terminal recognizes that the downlink data is not transmitted from the base station.

That is, as a feedback for the downlink data at the event of “PA termination,” NACK or DTX is used, and it is not necessary to prepare ACK.

In view of such a fact, the inventors propose a base station, a terminal, a feedback method, and a retransmission control method capable of avoiding a conflict of the response signal between a plurality of terminals even when the downlink allocation control channel (A-MAP) is overlooked at the even of “PA termination.”

### Embodiment 1

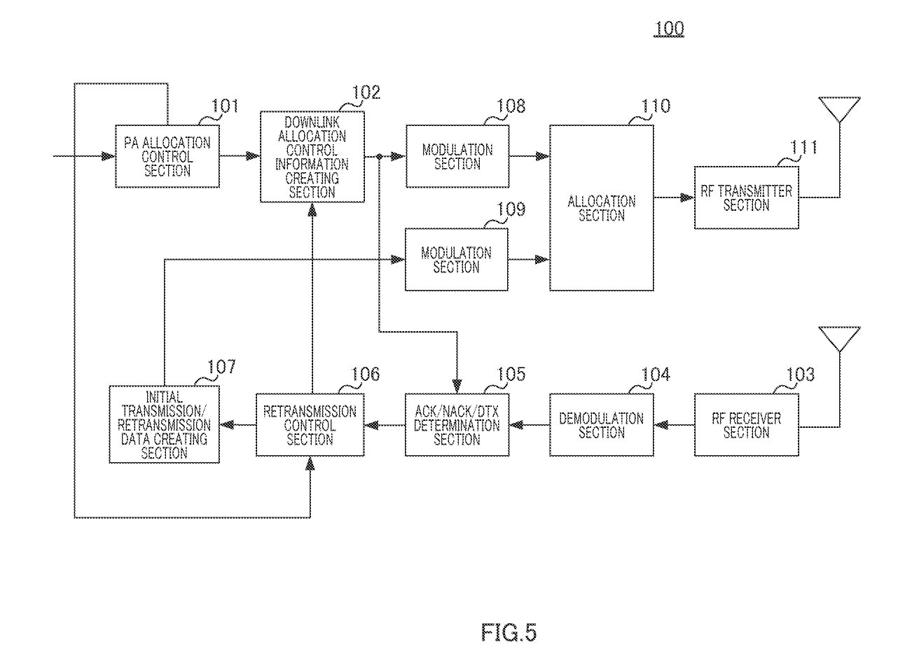

FIG. 5 is a block diagram illustrating a main configuration of base station 100 according to the present embodiment.

PA allocation control section 101 determines which of “PA initiation,” “PA allocation change,” or “PA termination” is performed, for example, depending on a request from each terminal. PA allocation control section 101 outputs the determination result to downlink allocation control information creating section 102 and retransmission control section 106.

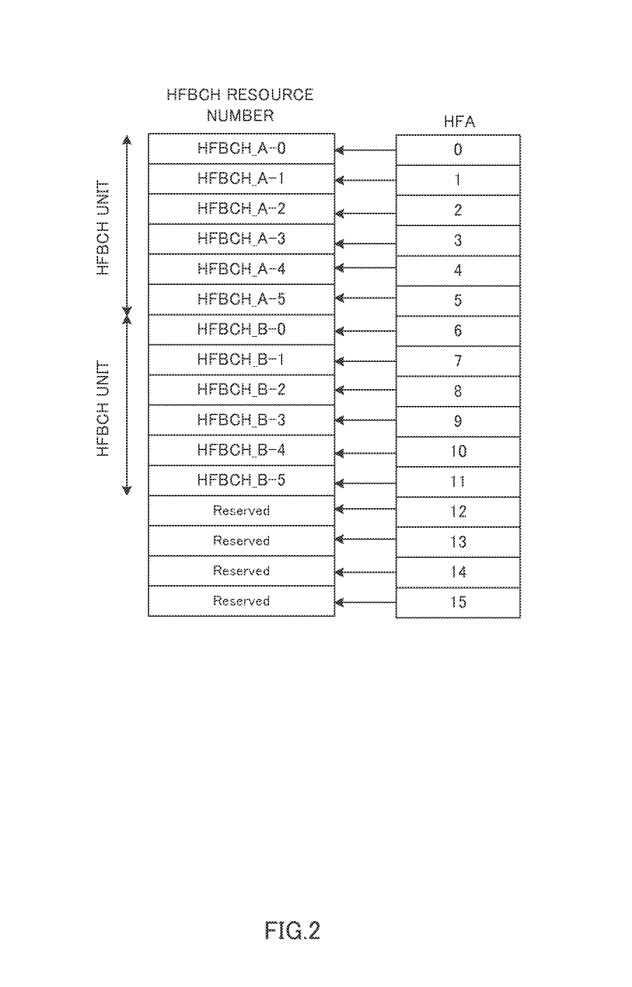

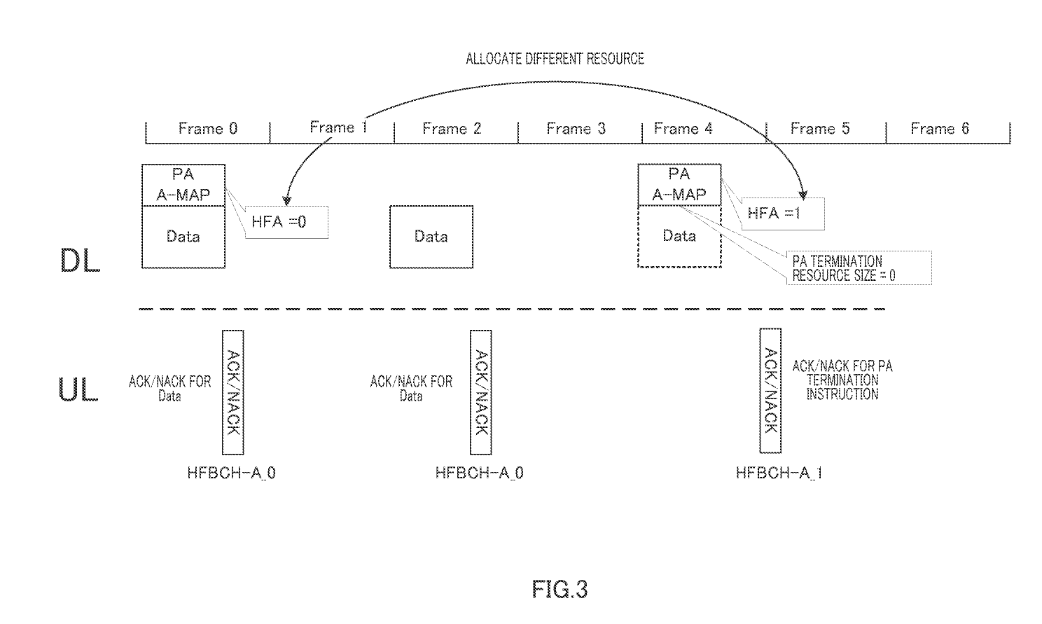

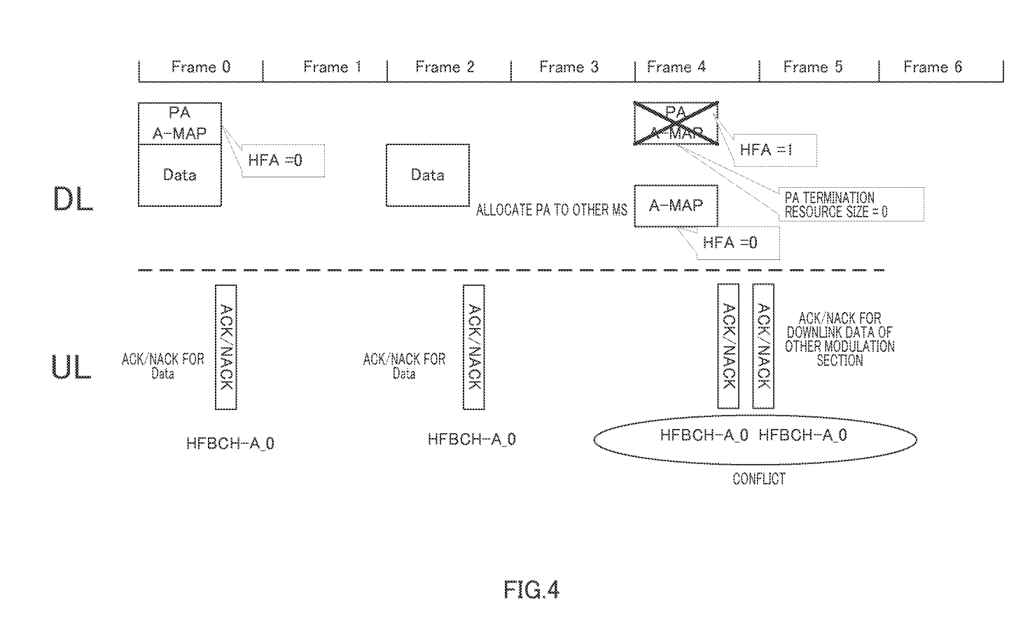

Downlink allocation control information creating section 102 determines the period of the downlink data resource for allocating the downlink data channel, the size and the position of the downlink data resource, and the ACK/NACK resource (data response resource) for the downlink data at the event of “PA initiation,” creates information thereon, and outputs it to modulation section 108. Hereinafter, description will be made for an exemplary case where the HFA number is used as an indicator for indicating the data response resource at the event of “PA initiation.” As shown in FIG. 2, the HFA number matches with the channel HFBCH of the response resource on a one-by-one basis.

At the event of “PA allocation change,” downlink allocation control information creating section 102 determines an allocation space change instruction and the ACK/NACK resource (control response resource) for the downlink allocation control information and outputs this information to modulation section 108. The allocation space change instruction contains information on the resource size and the position of the downlink data resource after the change. If information different from the information on the resource size or the position of the downlink data resource notified by the deallocation change instruction in the past is notified, the terminal recognizes that “PA allocation change” has been notified. In addition, similar to the data response resource, the HFA number may be used as an indicator for indicating the control response resource.

At the event of “PA termination,” downlink allocation control information creating section 102 sets the resource size of the downlink data resource to 0 and outputs this information to modulation section 108. If the resource size of the downlink data resource is 0, the terminal recognizes that the “PA termination” has been notified.

In addition, downlink allocation control information creating section 102 outputs information of the data response resource and the control response resource to ACK/NACK/DTX determination section 105.

RF receiver section 103 receives the signal transmitted from the terminal through a receiver antenna and performs a receiver process such as down-conversion, A/D conversion, and Fast Fourier Transform (FFT) for the received signal.

Demodulation section 104 demodulates the received signal subjected to the RF receiver process.

ACK/NACK/DTX determination section 105 extracts the response signal transmitted by the uplink response resource from the received signal subjected to the modulation based on the data response resource or the control response resource (hereinafter, these resources may be referred to as “uplink response resources”) notified from downlink allocation control information creating section 102. Then, ACK/NACK/DTX determination section 105 determines which of ACK, NACK or DTX the extracted response signal indicates. For example, if the power of the response signal is lower than a predetermined threshold value, ACK/NACK/DTX determination section 105 determines that the terminal transmits neither ACK nor NACK (DTX) using the uplink response resource. Otherwise, if the power of the response signal is equal to or higher than a predetermined threshold value, it is determined which of ACK or NACK the response signal indicates. ACK/NACK/DTX determination section 105 outputs, to retransmission control section 106, the determination result on which of ACK, NACK, or DTX the response signal indicates.

Retransmission control section 106 determines whether the terminal completes or overlooks “PA initiation” or “PA allocation change” and whether the terminal completes or overlooks “PA termination” based on the determination result from PA allocation control section 101 and the determination result from ACK/NACK/DTX determination section 105. The determination result from PA allocation control section 101 contains information regarding which of “PA initiation,” “PA allocation change,” or “PA termination” base station 100 determines to perform. Retransmission control section 106 determines whether or not the terminal can successfully receive the downlink data based on the determination result from PA allocation control section 101 and the determination result from ACK/NACK/DTX determination section 105. The determination method of retransmission control section 106 will be described below. Retransmission control section 106 outputs the determination results to initial transmission/retransmission data creating section 107 and downlink allocation control information creating section 102.

Initial transmission/retransmission data creating section 107 outputs, to modulation section 109, any one of the initial transmission downlink data or the retransmission downlink data based on the determination result from retransmission control section 106. Specifically, if the determination result indicates an error, initial transmission/retransmission data creating section 107 outputs retransmission downlink data to modulation section 109. Otherwise, if the determination result indicates no error, initial transmission/retransmission data creating section 107 outputs the initial transmission downlink data to modulation section 109.

Downlink allocation control information creating section 102 outputs the downlink allocation control information to modulation section 108 based on the determination result from retransmission control section 106. Specifically, if the determination result from retransmission control section 106 includes overlooking of “PA allocation change” and overlooking of “PA termination,” downlink allocation control information creating section 102 outputs the downlink allocation control information to modulation section 108 at the event of the previous “PA allocation change.” Otherwise, if the determination result from retransmission control section 106 is other than completion of the “PA allocation change” or completion of “PA termination,” and PA allocation control section 101 determines that “PA initiation” is performed in other terminals, downlink allocation control information creating section 102 creates downlink allocation control information including HFAs other than the HFA that has previously notified to the terminal and outputs this downlink allocation control information to modulation section 108.

Modulation section 108 modulates the downlink allocation control information.

Modulation section 109 modulates the initial transmission downlink data or the retransmission downlink data from initial transmission/retransmission data creating section 107.

Allocation section 110 allocates the modulated downlink data to the downlink data resource indicated by the downlink allocation control information and allocates the modulated downlink allocation control information to the downlink control resource of PA A-MAP.

RF transmitter section 111 performs a RF transmitter process such as Inverse Fast Fourier Transform (IFFT), D/A conversion, amplification, and up-conversion for the modulation signal allocated to the downlink data resource and the downlink control resource and transmits the signal subjected to the RF transmitter process through a transmitter antenna.

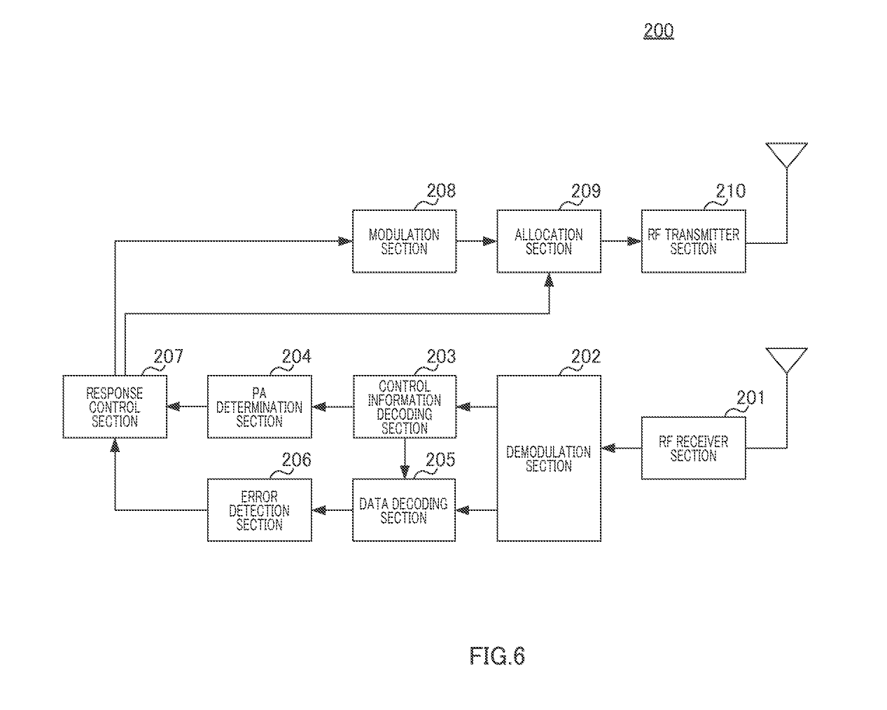

FIG. 6 is a block diagram illustrating a main part configuration of terminal 200 according to the present embodiment.

RF receiver section 201 receives the signal allocated to the downlink data channel (Data) and the downlink allocation control channel (A-MAP) transmitted from base station 100 through a receiver antenna and performs a receiver process such as down conversion, A/D conversion, and a FFT process for the received signal.

Demodulation section 202 demodulates the signal subjected to the RF receiver process.

Control information decoding section 203 extracts the downlink allocation control information from the demodulated signal and decodes the downlink allocation control information. Specifically, control information decoding section 203 de-masks the CRC of the downlink allocation control information using the ID of the host apparatus. If the CRC result indicates OK, control information decoding section 203 determines that the downlink allocation control information is destined to the host apparatus and outputs the decoded downlink allocation control information destined to the host apparatus to PA determination section 204. Otherwise, if the CRC result indicates NG, control information decoding section 203 determines that the downlink allocation control information is not destined to the host apparatus and performs nothing.

In addition, control information decoding section 203 outputs information on the resource size and the position of the downlink data resource out of the downlink allocation control information to data decoding section 205.

PA determination section 204 determines which of “PA initiation,” “PA allocation change,” or “PA termination” is notified from base station 100 based on the decoded downlink allocation control information. As described above, the downlink allocation control information contains information on the resource size and the position of the downlink data resource and the HFA number. PA determination section 204 stores the past downlink allocation control information and compares it with the current downlink allocation control information to determine which of “PA initiation,” “PA allocation change,” or “PA termination” is notified.

For example, PA determination section 204 determines that “PA initiation” is notified from base station 100 if the past resource size is 0, and the current resource size is not 0. In addition, PA determination section 204 determines that the “PA allocation change” is notified from base station 100 if the past information on the resource size or the position is modified. In addition, PA determination section 204 determines that “PA termination” is notified from base station 100 if the past resource size is not 0, and the current resource size is 0.

PA determination section 204 outputs the determination result to response control section 207. In addition, PA determination section 204 extracts the HFA number from the downlink allocation control information and outputs the HFA number to response control section 207.

Data decoding section 205 extracts the downlink data from the demodulated signal based on the information on the resource size and the position of the downlink data resource notified from the control information decoding section 203 and decodes the extracted downlink data.

Error detection section 206 detects an error in the decoded downlink data, for example, using CRC and outputs the error detection result to the response control section 207.

Response control section 207 controls transmission of the response signal used in the retransmission control of the downlink data and the downlink allocation control information based on the error detection result obtained from error detection section 206 and the determination result obtained from PA determination section 204. A method of controlling transmission of the response signal in response control section 207 will be described below. Response control section 207 outputs information of the response resource for allocating the response signal to allocation section 209.

Modulation section 208 modulates the response signal from response control section 207 and outputs the result to allocation section 209.

Allocation section 209 allocates the modulated response signal to the response resource notified from response control section 207.

RF transmitter section 210 performs a RF transmitter process such as an IFFT process, D/A conversion, amplification, and up-conversion for the modulation signal from allocation section 209 and transmits the signal subjected to the RF transmitter process through a transmitter antenna.

[Operations of Base Station 100 and Terminal 200]

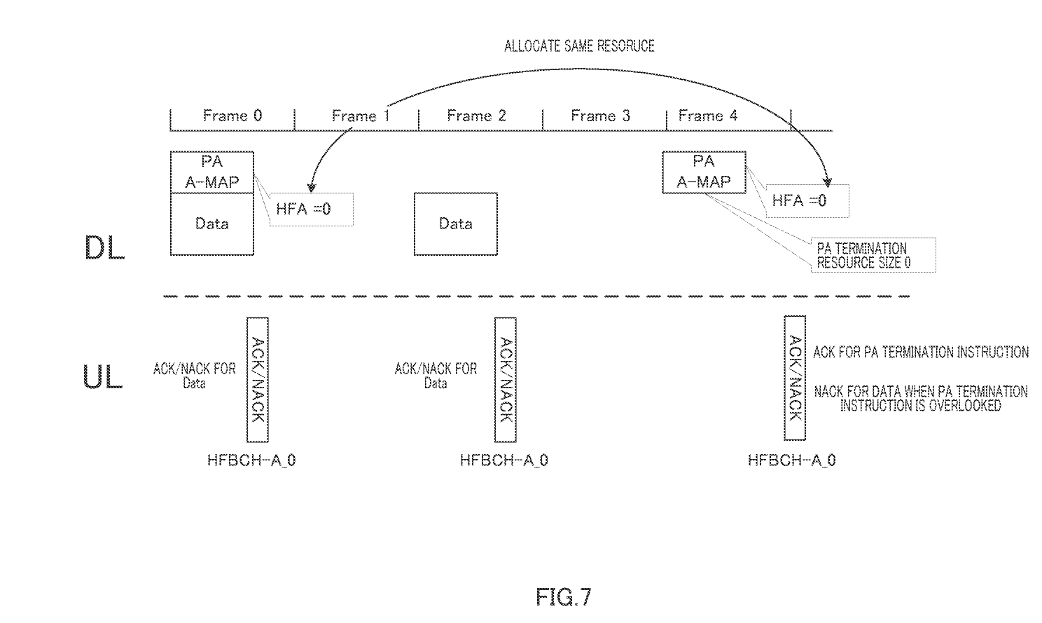

Operations of base station 100 and terminal 200 having the configurations described above will be described with reference to FIG. 7.

<Control of Resource Allocation Using Base Station 100>

Base station 100 transmits, to terminal 200, DATA and PA A-MAP for notifying the “PA initiation” instruction in Frame 0 and transmits a data channel in Frame 2. FIG. 7 illustrates an example in which downlink allocation control information creating section 102 creates downlink allocation control information of HFA=0 such that HFBCH-A_0 is used as a data response resource for allocating the response signal for the downlink data at the event of “PA initiation.”

In addition, base station 100 transmits PA A-MAP for notifying the “PA termination” instruction in Frame 4 to terminal 200. In order to notify the “PA termination” instruction, downlink allocation control information creating section 102 creates downlink allocation control information indicating that resource size=0.

<Receiving of Downlink Data in Terminal 200>

In terminal 200, control information decoding section 203 determines whether or not PA-A-MAP contains downlink allocation control information destined to the host apparatus and outputs the downlink allocation control information destined to itself to PA determination section 204. In addition, control information decoding section 203 obtains information on the position of the downlink resource from the downlink allocation control information destined to the host apparatus and outputs the obtained information on the position of the downlink resource to data decoding section 205.

Data decoding section 205 extracts downlink data from the received signal based on the information on the position of the downlink resource received from control information decoding section 203.

In this manner, terminal 200 receives downlink data transmitted from base station 100.

<Response in Terminal 200>

Error detection section 206 performs error detection for the received downlink data and outputs the error detection result to response control section 207.

In addition, response control section 207 performs transmission control of the response signal based on the error detection result received from error detection section 206, the determination result received from PA determination section 204, and information of the downlink resource as follows.

[1] When Determination Result from PA Determination Section 204 Indicates No “PA Termination”

Response control section 207 creates the response signal indicating the error detection result of downlink data. In addition, response control section 207 outputs, to allocation section 209, information of the data response resource for allocating the response signal indicating the error detection result of downlink data. For example, response control section 207 outputs, to allocation section 209, information of HFBCH corresponding to the HFA number contained in the downlink allocation control information at the event of “PA initiation” as information of the data response resource.

[2] When Determination Result from PA Determination Section 204 Indicates “PA Allocation Change” or “PA Termination”

Response control section 207 creates, as a response signal, ACK indicating that downlink allocation control information for notifying the “PA allocation change” or “PA termination” is successfully received. In addition, response control section 207 outputs, to allocation section 209, information of the control response resource for allocating ACK.

Specifically, if the determination result from PA determination section 204 indicates “PA allocation change,” response control section 207 outputs, to allocation section 209, information of HFBCH corresponding to the HFA number contained in the downlink allocation control information at the event of “PA allocation change” as information of the control response resource. In addition, if the determination result from PA determination section 204 indicates “PA termination,” response control section 207 outputs information of the data response resource to allocation section 209 by using the same resource as the data response resource for allocating the response signal for downlink data to the control response resource.

In this manner, if the determination result from PA determination section 204 indicates “PA termination,” ACK for the downlink allocation control information is fed back to base station 100 by using the same resource as the data response resource for allocating the response signal for the downlink data. In addition, if the determination result from PA determination section 204 indicates “PA initiation,” terminal 200 does not transmit, to base station 100, the response signal corresponding to whether or not the downlink allocation control information for notifying the “PA initiation” instruction is successfully received.

Referring to FIG. 7, terminal 200 feeds back ACK/NACK for DATA as the response signal to base station 100 using HFBCH-A_0 in Frame 0 and Frame 2. In addition, if terminal 200 successfully receives the downlink allocation control information for notifying the “PA termination” instruction in Frame 4 and determines that “PA termination” is performed, ACK as the response signal is fed back to base station 100 using HFBCH-A_0. In addition, if the downlink allocation control information for notifying the “PA termination” instruction is not successfully received (overlooked) in Frame 4, and it is determined “PA termination” is not performed, terminal 200 waits for arrival of the downlink data in the downlink data resource. However, since the downlink data is not transmitted in reality, terminal 200 feeds back NACK as the response signal to base station 100 using HFBCH-A_0.

In this manner, transmission of the response signal used in the retransmission control of the downlink data and the downlink allocation control information is controlled based on the determination result regarding whether or not “PA termination” is performed.

<Response in Base Station 100>

Retransmission control section 106 determines any one of whether the terminal completes or overlook “PA initiation” or “PA allocation change” or whether the terminal completes or overlooks “PA termination” based on the determination result from PA allocation control section 101 and the determination result from the ACK/NACK/DTX determination section 105.

[1] When Determination Result from PA Allocation Control Section 101 Indicates “PA Initiation”

ACK/NACK/DTX determination section 105 extracts the response signal transmitted with the data response resource from the received signal subjected to modulation based on information of data response resource notified from downlink allocation control information creating section 102 and determines which of ACK/NACK/DTX the extracted response signal is.

If the determination result from ACK/NACK/DTX determination section 105 is ACK, retransmission control section 106 determines that the terminal successfully receives the downlink data and notifies this fact to initial transmission/retransmission data creating section 107. In this case, initial transmission/retransmission data creating section 107 outputs initial transmission downlink data to modulation section 109.

If the determination result from ACK/NACK/DTX determination section 105 is NACK, retransmission control section 106 determines that the terminal fails to receive the downlink allocation control information and notifies this fact to downlink allocation control information creating section 102. In this case, downlink allocation control information creating section 102 outputs, to modulation section 108, information on the period of the downlink data resource for allocating the downlink data channel determined at the event of “PA initiation,” the resource size and the position of the downlink data resource, and the ACK/NACK resource (data response resource) for the downlink data.

[2] When Determination Result from PA Allocation Control Section 101 Indicates “PA Allocation Change”

ACK/NACK/DTX determination section 105 extracts the response signal transmitted with the data response resource and the response signal transmitted with the control response resource from the received signal subjected to modulation and determines which of ACK/NACK/DTX each of the extracted response signal corresponds to, based on data response resource notified from downlink allocation control information creating section 102 and information of the control response resource.

If the determination result for the downlink control information from ACK/NACK/DTX determination section 105 is ACK, retransmission control section 106 determines that terminal 200 successfully receives the PA allocation change (deallocation) instruction. If the determination result for the downlink data from ACK/NACK/DTX determination section 105 is ACK, retransmission control section 106 determines that terminal 200 successfully receives the PA allocation change (deallocation) instruction and notifies this fact to initial transmission/retransmission data creating section 107. In this case, initial transmission/retransmission data creating section 107 outputs initial transmission downlink data to modulation section 109.

If the determination result for the downlink control information from ACK/NACK/DTX determination section 105 is NACK, retransmission control section 106 determines that terminal 200 fails to receive the “PA allocation change” instruction and notifies this fact to initial transmission/retransmission data creating section 107 and downlink allocation control information creating section 102. In this case, initial transmission/retransmission data creating section 107 outputs, to modulation section 109, the downlink data transmitted at the event of “PA allocation change” as the retransmission downlink data. In addition, downlink allocation control information creating section 102 outputs, to modulation section 108, the downlink allocation control information transmitted at the event of “PA allocation change.”

[3] When Determination Result from PA Allocation Control Section 101 Indicates “PA Termination”

ACK/NACK/DTX determination section 105 extracts the response signal transmitted with data response resource from the received signal subjected to modulation based on information of the control response resource and the data response resource notified from downlink allocation control information creating section 102 and determines which of ACK/NACK/DTX the extracted response signal corresponds to.

If the determination result from ACK/NACK/DTX determination section 105 is ACK, retransmission control section 106 determines that terminal 200 successfully receives the “PA termination” instruction and notifies this fact to initial transmission/retransmission data creating section 107. In this case, initial transmission/retransmission data creating section 107 outputs initial transmission downlink data to modulation section 109.

If the determination result from ACK/NACK/DTX determination section 105 is NACK, retransmission control section 106 determines that terminal 200 fails to receive the “PA termination” instruction and notifies this fact to downlink allocation control information creating section 102. Downlink allocation control information creating section 102 outputs, to modulation section 108, the downlink allocation control information transmitted at the event of “PA termination.”

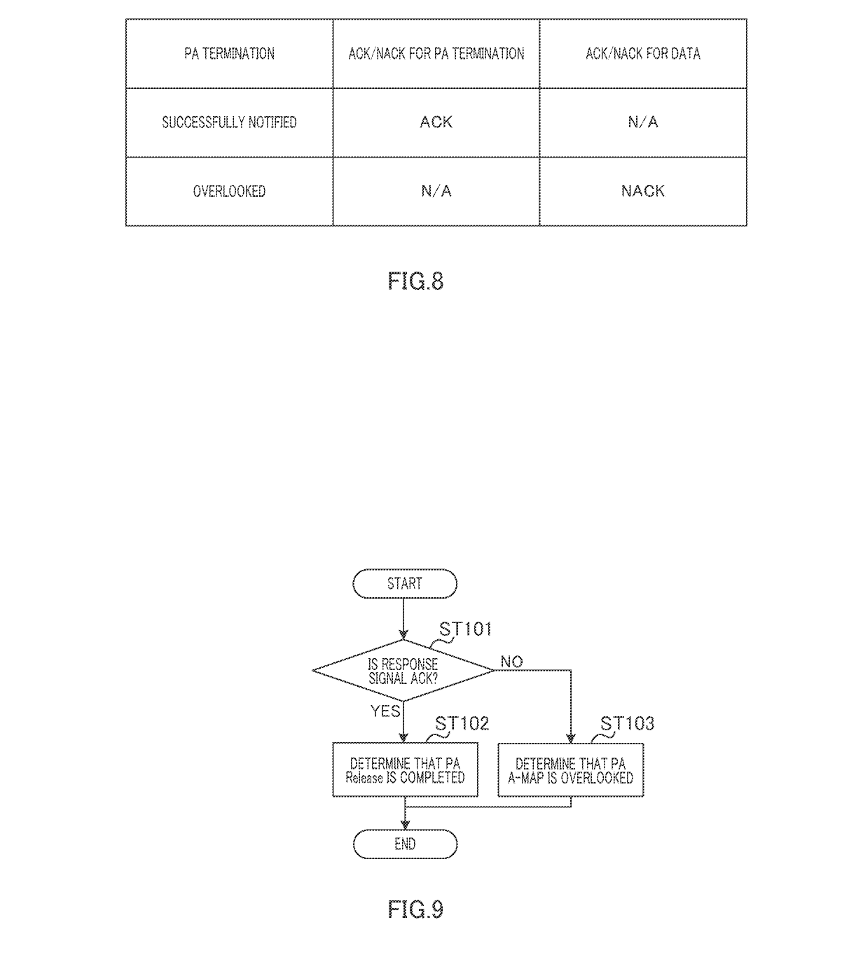

A method of determining overlooking of the “PA termination” instruction in retransmission control section 106 will be described with reference to FIGS. 8 and 9.

FIG. 8 illustrates a combination of ACK/NACK/DTX for the downlink data and the downlink allocation control information contemplated at the event of “PA termination” when the retransmission control is performed according to the present embodiment. FIG. 9 is a diagram illustrating a determination flow in retransmission control section 106.

As shown in FIG. 9, it is determined whether or not the response signal for the downlink allocation control information for notifying the “PA termination” instruction is ACK (ST101). If the response signal is ACK (if the response signal for downlink data is N/A(DTX)), retransmission control section 106 determines that the “PA termination” is successfully notified to terminal 200 (ST102).

If the response signal for the downlink allocation control information for notifying “PA termination” is N/A(DTX) (if the response signal for downlink data is NACK), retransmission control section 106 determines that “PA termination” is not successfully notified to terminal 200, and PA A-MAP for notifying the “PA termination” instruction is overlooked (ST103).

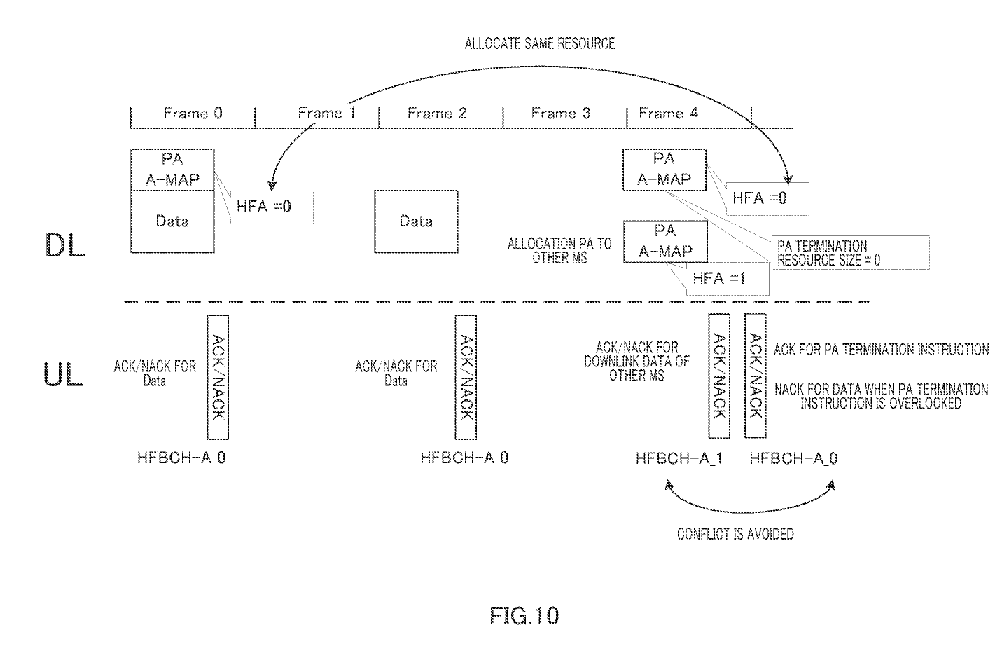

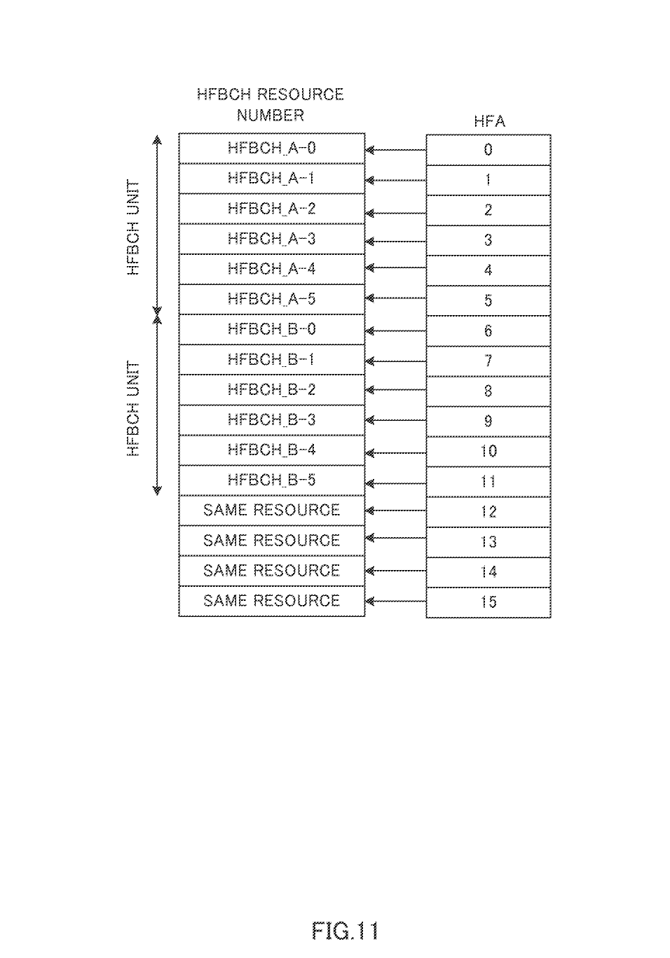

As described above, terminal 200 transmits ACK for informing that the downlink allocation control information for notifying the “PA termination” instruction is successfully received at the event of “PA termination” using HFBCH-A_0 used to transmit the response signal for the downlink data. As a result, even when the downlink allocation control information for notifying PA termination is not successfully received, and PA A-MAP for notifying the “PA termination” instruction is overlooked, it is possible to avoid a conflict with other terminals as described below. How to avoid a conflict with other terminals will be described with reference to FIG. 10.

FIG. 10 illustrates DL and UL in a case where base station 100 notifies the “PA termination” instruction to terminal 200 in Frame 4, and “PA initiation” is performed in other terminals.

Base station 100 notifies the “PA termination” instruction to terminal 200 by transmitting the downlink allocation control information in which the resource size of the downlink data resource is set to 0. If terminal 200 successfully receives the downlink allocation control information, ACK is transmitted from terminal 200 using HFBCH-A_0. Otherwise, if terminal 200 overlooks PA A-MAP for notifying “PA termination” instruction, NACK for downlink data is transmitted using HFBCH-A_0.

Otherwise, as an indicator for indicating the data response resource to other terminals, base station 100 notifies an indicator different from HFA=0(HFBCH-A_0). In the example shown in FIG. 10, HFA=1(HFBCH-A_1) is notified to other terminals.

As described above, terminal 200 transmits ACK for informing that the downlink allocation control information for notifying the “PA termination” instruction is successfully received at the event of “PA termination” using HFBCH-A_0 used to transmit the response signal for downlink data. In addition, even when terminal 200 overlooks PA A-MAP for notifying the “PA termination” instruction, NACK for downlink data is transmitted from terminal 200 using HFBCH-A_0. In this manner, regardless of whether or not the downlink allocation control information for notifying the “PA termination” instruction is successfully received, the response signal is transmitted from terminal 200 using HFBCH-A_0. Therefore, it is possible to avoid a conflict between terminal 200 and other terminals.

In addition, base station 100 may determine whether or not the downlink allocation control information for notifying the “PA termination” instruction is successfully received by terminal 200 by monitoring the data response resource notified using the downlink allocation control information at the event of “PA termination.” In this manner, according to the present embodiment, terminal 200 can feed back ACK for downlink allocation control information and NACK indicating that the downlink allocation control information is overlooked to base station 100 using the same resource. Therefore, it is possible to avoid a conflict between terminal 200 and other terminals in the uplink resource. Since terminal 200 can notify base station 100 of ACK/NACK for the downlink allocation control information for notifying the “PA termination” instruction using the data response resource for allocating ACK/NACK for downlink data without adding a new resource, it is possible to facilitate effective use of resources.

As described above, according to the present embodiment, response control section 207 transmits ACK/NACK depending on the error result of downlink data using the data response resource notified by the downlink allocation control information. If PA determination section 204 determines “PA termination,” response control section 207 performs control such that ACK is transmitted as a response signal to the downlink allocation control information using same resources as the data response resource.

As described above, base station 100 allows terminal 200 to determine “PA termination” by transmitting the downlink allocation control information indicating that the resource size is 0 to terminal 200. In this case, base station 100 sets the HFA in the downlink allocation control information at the event of “PA termination” to the same value as the HFA in the downlink allocation control information at the event of “PA initiation” so as to allocate the same resource. As a result, terminal 200 can feed back the response signal for the downlink allocation control information at the event of “PA termination” to base station 100 using the same resource as the data response resource for allocating the response signal to downlink data even when the HFA at the event of “PA termination” is used without storing HFA at the event of “PA initiation.”

How to notify that the same resource is used is not limited that described above, and the following methods #1 or #2 may be used.

[Method #1]

As illustrated in FIG. 2, the HFA has four indices where HFBCH is not allocated. In FIG. 2, HFBCH is not allocated to the HFA numbers 12, 13, 14, and 15. In this regard, as shown in FIG. 11, the HFA numbers 12, 13, 14, and 15 where HFBCH is not allocated are used as indices for indicating the same resource as the data response resource for allocating the response signal for the downlink data in the past. If the HFA number is 12, 13, 14, or 15, terminal 200 determines that ACK for the downlink allocation control information is transmitted using the data response resource.

[Method #2]

As described above, once “PA initiation” is performed, terminal 200 uses the same resource as the data response resource until “PA termination.” The HFA indicating information of the data response resource is contained in the downlink allocation control information transmitted from base station 100 to terminal 200 at the event of “PA initiation.” Therefore, terminal 200 can transmit ACK for the downlink allocation control information using the data response resource by storing the HFA notified at the event of PA initiation even when base station 100 does not notify terminal 200 of information of the resource for allocating ACK for the downlink allocation control information at the event of “PA termination.”

### Embodiment 2

In the present embodiment, an example of notifying the “PA termination” timing will be described.

In Embodiment 1, description has been made for a case where the HFA is used as information indicating the response resource in the downlink allocation control information. As described in Embodiment 1, if the “PA termination” instruction is successfully received, and “PA termination” is determined, the terminal transmits ACK for the downlink allocation control information using the data response resource. For this reason, as described in [Method #2] in Embodiment 1, the base station is not necessary to notify the terminal of information indicating the data response resource at the event of “PA termination.” In this regard, according to the present embodiment, the “PA termination” timing is notified using the HFA.

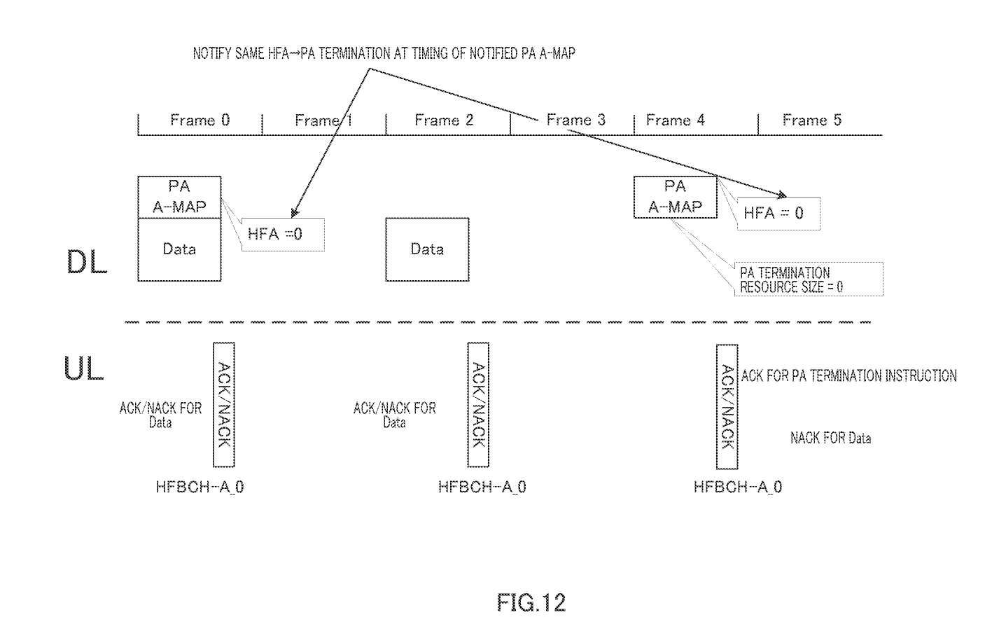

Since the configurations of the base station and the terminal according to Embodiment 2 is similar to those of Embodiment 1, and description will be made by similarly referring to FIGS. 5 and 6.

[1] When “PA Termination” is Performed in the Frame Used to Notify PA A-MAP (Refer to FIG. 12)

Base station 100 transmits DATA and PA A-MAP for notifying the “PA initiation” instruction to terminal 200 in Frame 0 and transmits only the DATA channel in Frame 2.

In addition, base station 100 transmits, to terminal 200, PA A-MAP for notifying the “PA termination” instruction in Frame 4. In order to notify the “PA termination” instruction, downlink allocation control information creating section 102 creates the downlink allocation control information indicating that resource size=0.

In addition, according to the present embodiment, in order to perform “PA termination” in Frame 4 used to notify the “PA termination” instruction, downlink allocation control information creating section 102 sets the HFA number contained in the downlink allocation control information of “PA termination” to the same number as the HFA number of “PA initiation.” In this manner, when the “PA termination” is performed at the timing used to notify the “PA termination” instruction, base station 100 notifies the same number as the HFA number of “PA initiation.”

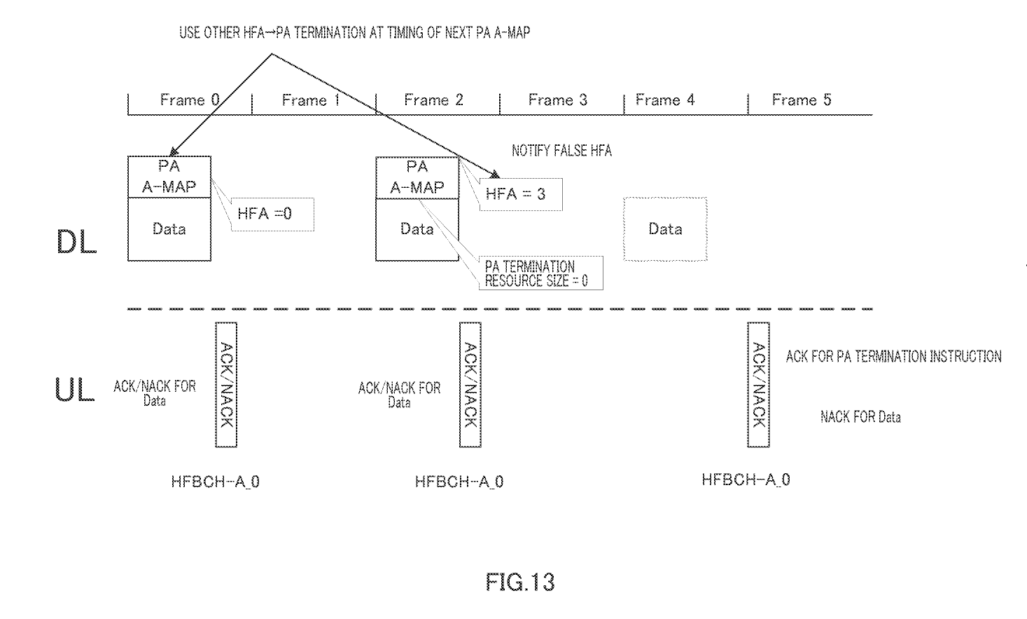

If the determination result from PA determination section 204 indicates “PA termination,” and the HFA number contained in the downlink allocation control information in the “PA termination” instruction is equal to the HFA number of “PA initiation,” terminal 200 determines that “PA termination” is performed in the frame used to notify the “PA termination” instruction.

[2] When “PA Termination” is Performed in Frame Preceded by Frame Used to Notify PA A-MAP (Refer to FIG. 13)

Base station 100 transmits DATA and PA A-MAP for notifying “PA initiation” instruction to terminal 200 in Frame 0. In addition, base station 100 transmits DATA and PA A-MAP for notifying the “PA termination” instruction to terminal 200 in Frame 4. In order to notify the “PA termination” instruction, downlink allocation control information creating section 102 creates downlink allocation control information indicating that resources size=0.

In addition, according to the present embodiment, in order to perform “PA termination” at the PA A-MAP timing (in Frame 4 when the period is set to 2 frames) preceded by Frame 2 used to notify the “PA termination” instruction, downlink allocation control information creating section 102 sets the HFA number contained in the downlink allocation control information of “PA termination” to a number different from the HFA number of “PA initiation.” In this manner, in a case where “PA termination” is performed at the PA A-MAP timing preceded by the timing used to notify the “PA termination” instruction, base station 100 notifies a number different from the HFA number of “PA initiation” (notifies false HFA).

If the determination result from PA determination section 204 indicates “PA termination,” and the HFA number contained in the downlink allocation control information in the “PA termination” instruction is different from the HFA number of “PA initiation,” terminal 200 determines that “PA termination” is performed at the PA A-MAP timing preceded by the timing used to notify the “PA termination” instruction.

As described above, according to the present embodiment, the downlink allocation control information contains the HFA number indicating the data response resource at the event of “PA initiation” and contains the HFA number indicating the control response resource for notifying ACK for the downlink allocation control information at the event of “PA termination.” In addition, PA determination section 204 determines that “PA termination” is performed at the next period if the HFA number indicating the control response resource is different from the HFA number indicating the data response resource.

In this manner, base station 100 sets the HFA of “PA termination” to a number equal to or different from the HFA of “PA initiation” depending on whether or not the timing for notifying the “PA termination” instruction matches with the timing for actually performing “PA termination.” As a result, terminal 200 can determine the timing of “PA termination” by comparing these HFAs.

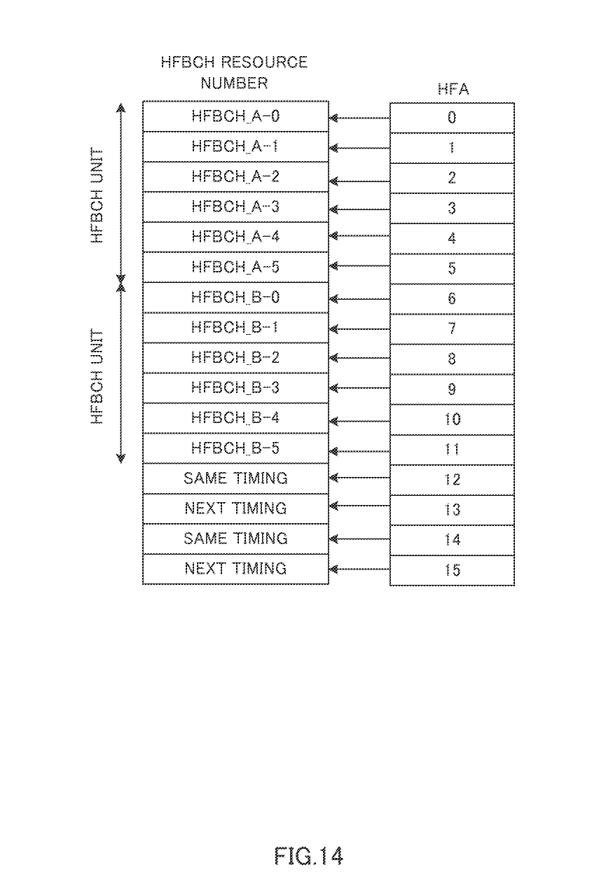

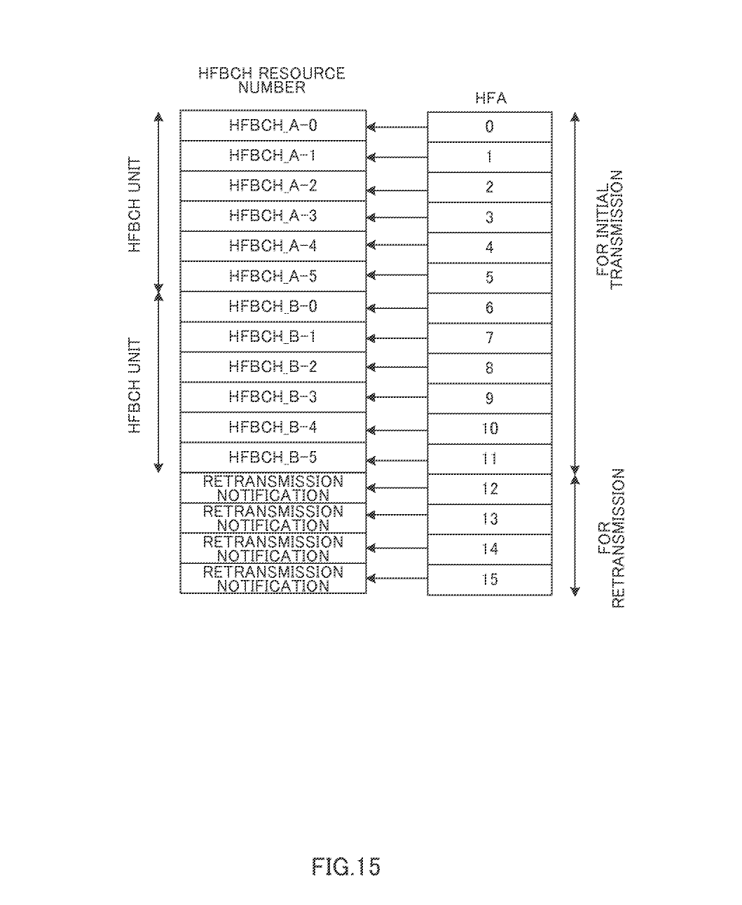

In addition, base station 100 may be configured to explicitly notify terminal 200 of the timing of “PA termination” using the index of HFA. A mapping example of HFA and HFBCH or timings in this case is illustrated in FIG. 14.

In the example of FIG. 14, base station 100 notifies 13 or 15 as the HFA number when a fact that the actual “PA termination” is performed is notified at the timing of PA A-MAP preceded by the timing used to notify the “PA termination” instruction.

### Embodiment 3

In Embodiment 2, the base station notifies, in advance, the terminal of the timing for actually performing “PA termination.” In this case, the base station was set to wait for retransmission control when the terminal overlooks PA A-MAP until ACK/NACK is notified from the terminal at the next PA A-MAP timing.

According to the present embodiment, there is proposed a method capable of performing early overlooking of PA A-MAP even when the “PA termination” is notified in advance.

Since the configurations of the base station and the terminal of Embodiment 3 are similar to those of Embodiment 1, description will be made by similarly referring to FIGS. 5 and 6. According to the present embodiment, description will be made for a case where terminal 200 determines, using the index of HFA, whether the “PA termination” instruction notified from base station 100 is for initial transmission or retransmission. A mapping example between HFA and HFBCH or retransmission notification is illustrated in FIG. 15. In the example of FIG. 15, base station 100 notifies 12 to 15 as the HFA number in order to notify that the “PA termination” instruction is for retransmission.

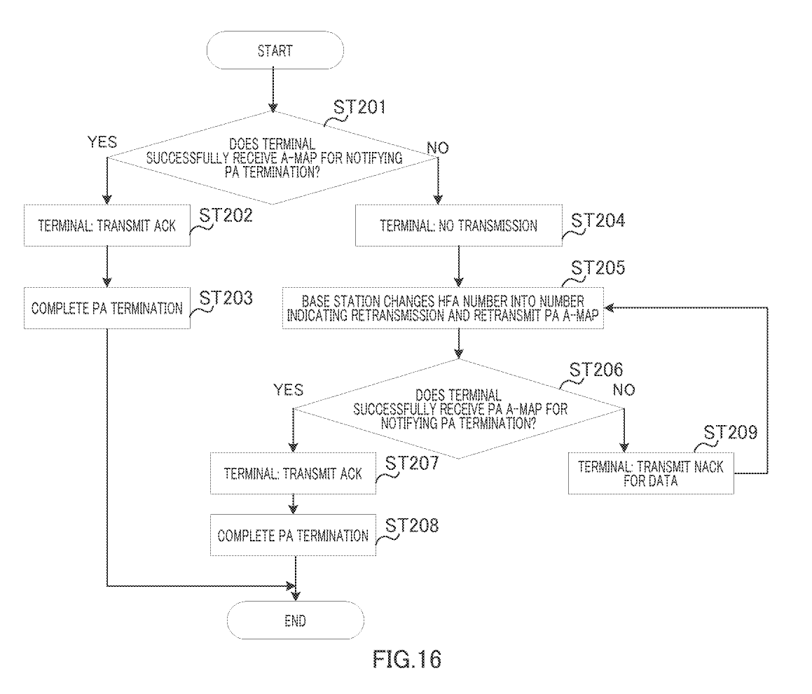

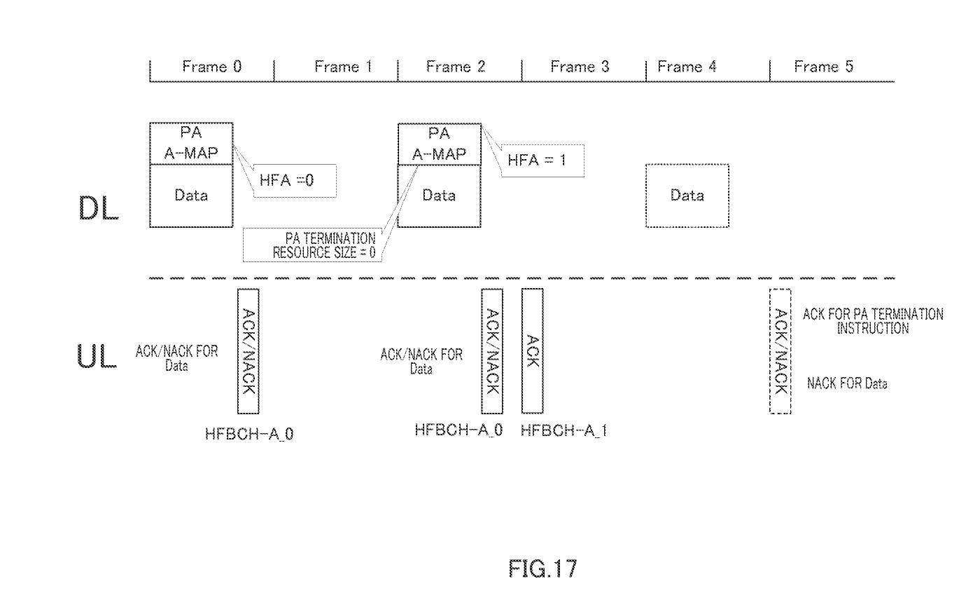

Hereinafter, operations of base station 100 and terminal 200 will be described with reference to FIGS. 16, 17, and 18. FIG. 16 is a flowchart illustrating operations of base station 100 and terminal 200.

(1) When “PA Termination” Instruction is for Initial Transmission

In order to notify the “PA termination” instruction for initial transmission, base station 100 notifies the downlink allocation control information of HFA indicating the control response resource. In this case, terminal 200 feeds back ACK/NACK for the downlink allocation control information to base station 100 using the control response resource.

For example, as shown in FIG. 17, HFA=1 is notified as HFA indicating the control response resource. If terminal 200 successfully receives the downlink allocation control information for notifying the “PA termination” instruction (YES in ST201), terminal 200 feeds back ACK as the response signal to base station 100 using HFBCH-A_1 (ST202). As a result, “PA termination” is completed (ST203).

(2) When “PA Termination” Instruction is for Retransmission

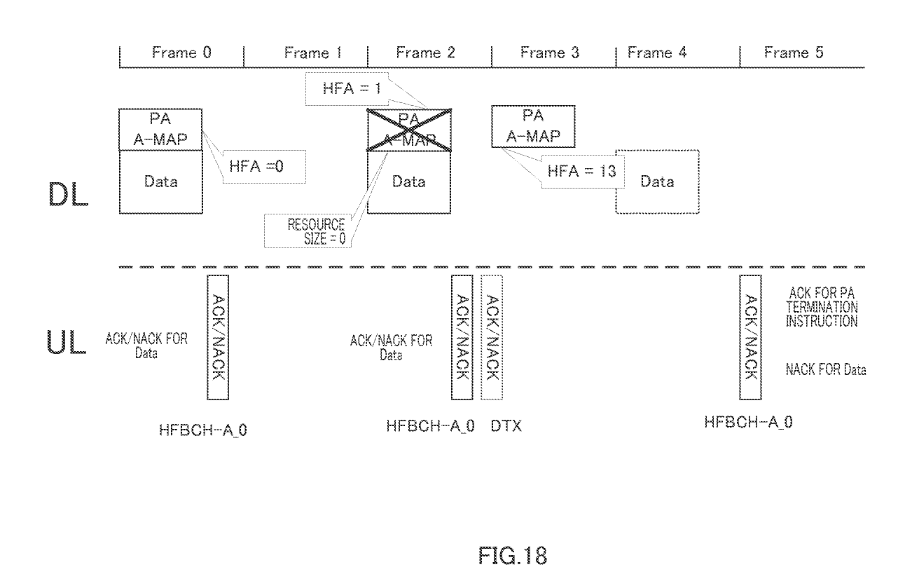

If terminal 200 fails to receive the downlink allocation control information for notifying the “PA termination” instruction (NO in ST201), and ACK is not fed back to base station 100 from terminal 200 using HFBCH-A_1 (ST204), base station 100 determines that terminal 200 overlooks PA A-MAP of the “PA termination” instruction of the initial transmission. In this case, base station 100 retransmits PA A-MAP by changing the HFA number (ST205). For example, as shown in FIG. 18, base station 100 changes the HFA into 13 which indicates that PA A-MAP is for retransmission.

Similar to Embodiment 1, if terminal 200 successfully receives the downlink allocation control information for notifying the “PA termination” instruction of retransmission (YES in ST206), ACK is fed back to base station 100 using HFBCH-A_0 as the response signal (ST207). As a result, “PA termination” is completed (ST208).

Similar to Embodiment 1, if terminal 200 fails to receive the downlink allocation control information for notifying the “PA termination” instruction of retransmission (NO in ST206), NACK for the downlink data is fed back to base station 100 using HFBCH-A 0 as the response signal (ST209). Then, returning to ST205, the same process is repeated until “PA termination” is completed (ST208).

In this manner, according to the present embodiment, the HFA number of downlink allocation control information indicates whether the notification of the “PA termination” instruction is for initial transmission or retransmission. If the “PA termination” instruction is for initial transmission, response control section 207 transmits ACK as the response signal to the downlink allocation control information using the control response resource. In addition, if “PA termination” is for retransmission, response control section 207 transmits ACK as the response signal for the downlink allocation control information using the data response resource.

As a result, in comparison with Embodiment 2, it is possible to determine DTX of PA A-MAP at the event of PA A-MAP transmission, and thus, expedite the retransmission. Although the retransmission of PA A-MAP of the “PA termination” instruction is performed after Frame 4 in Embodiments 1 and 2, PA A-MAP of the “PA termination” instruction is retransmitted in Frame 3 as shown in FIG. 18 according to the present embodiment.

### Embodiment 4

In Embodiment 4, HFA is not explicitly notified unlike Embodiment 1.

For example, as in the 3rd Generation Partnership Project Radio Access Network Long Term Evolution (3 GPP LTE), there may be a case where HFA is not explicitly notified in order to reduce the signaling amount. Specifically, the position of the downlink control resource for allocating PA A-MAP matches with the response resource on a one-by-one basis. For brevity purposes, a case where the position of the downlink control resource is indicated by a frequency of the leading resource of the downlink control resources will be exemplarily described.

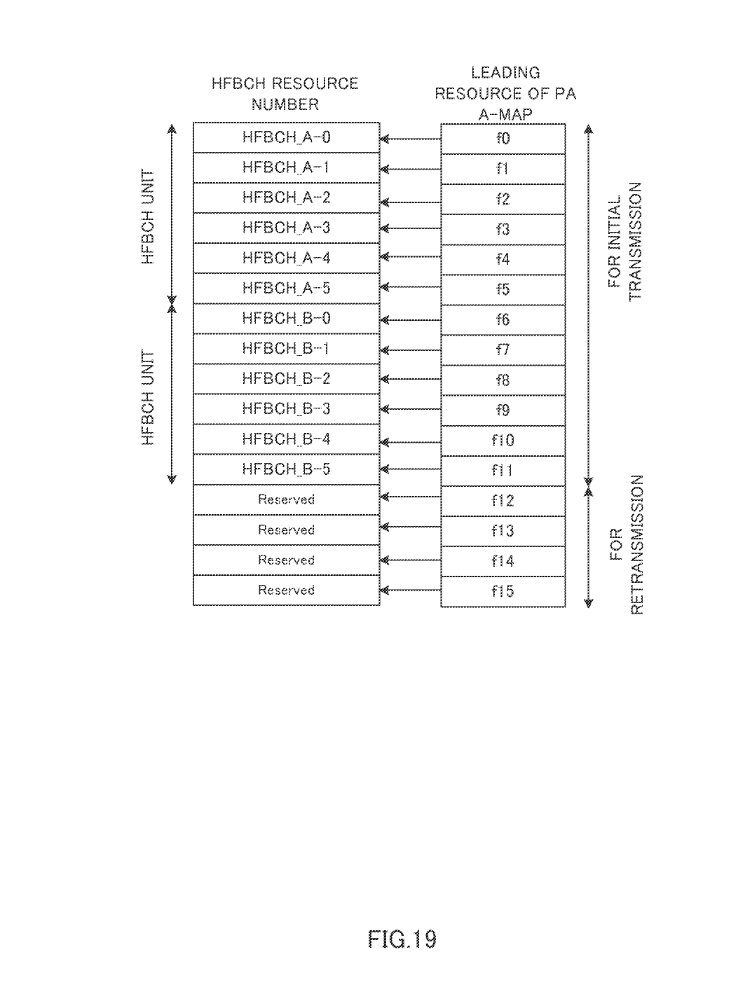

FIG. 19 is a diagram illustrating a mapping example between the frequency of the leading resource of the downlink control resources and the response resource.

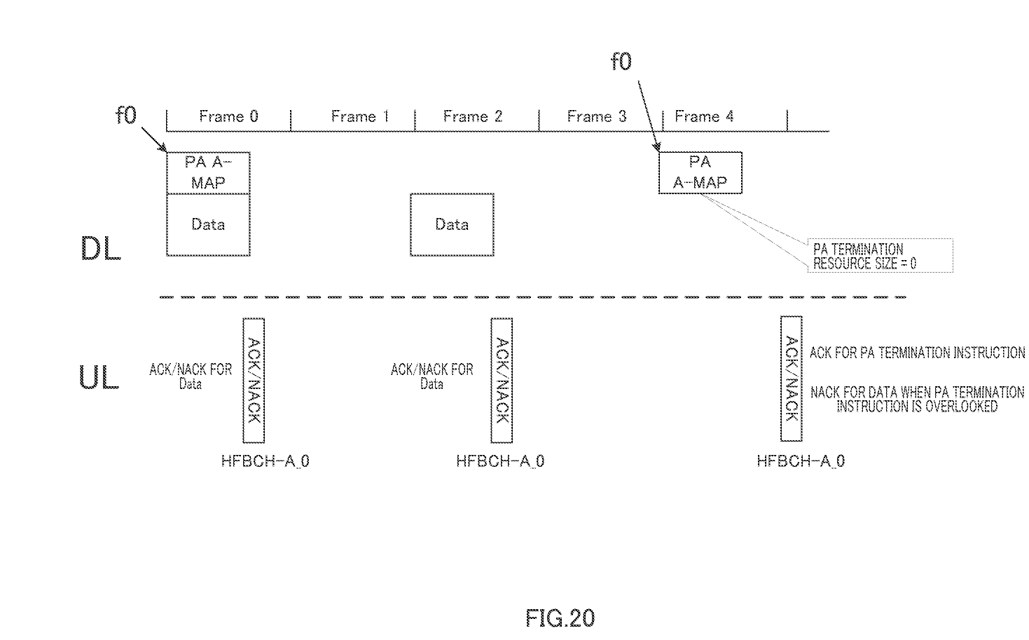

In FIG. 20, PA A-MAP for notifying the “PA termination” instruction in Frame 4 is allocated to the same position as that of the downlink control resource where the PA A-MAP for notifying the “PA initiation” instruction is allocated, and the frequency of the leading resource is set to “f0.” In this case, terminal 200 uses HFBCH_A-0 as the response resource as shown in FIG. 19. Subsequently, similar to Embodiment 1, terminal 200 feeds back the response signal for the downlink allocation control information to base station 100 using this response resource.

By mapping the position of the downlink control resource for allocating PA A-MAP and the response resource on a one-by-one basis in this manner, base station 100 is terminated without notifying HFA. Therefore, it is possible to reduce the signaling amount.

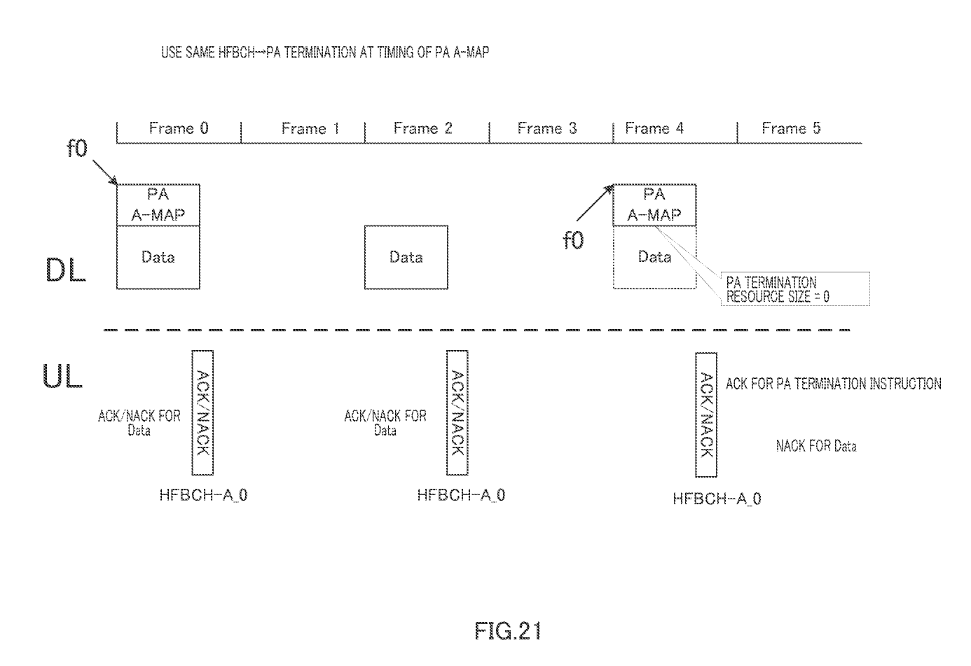

In addition, also in Embodiment 2, by mapping the position of the downlink control resource for allocating PA A-MAP and the response resource on a one-by-one basis as shown in FIG. 21, base station 100 is terminated without notifying HFA, and it is possible to reduce the signaling amount.

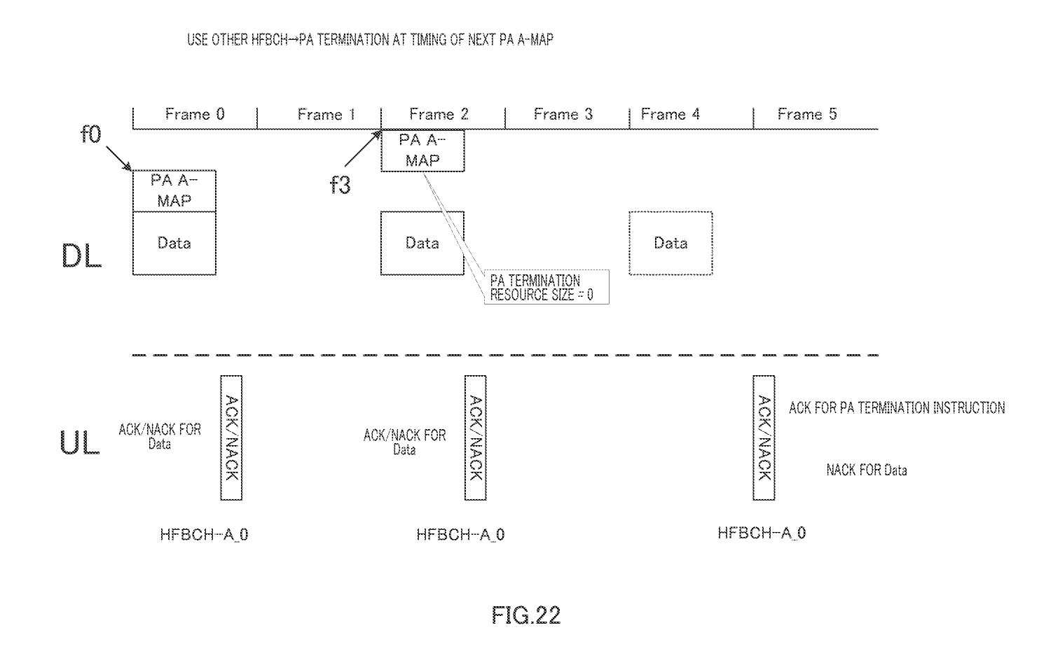

In addition, also in Embodiment 3, by mapping the position of the downlink control resource for allocating PA A-MAP and the response resource on a one-by-one basis as shown in FIG. 22, base station 100 is terminated without notifying HFA, and it is possible to reduce the signaling amount.

In addition, although an antenna has been described in the aforementioned embodiments, the present invention may be similarly applied to an antenna port.

The antenna port refers to a logical antenna including a single or a plurality of physical antenna(s). That is, the antenna port is not limited to a single physical antenna, but may refer to an array antenna including a plurality of antennas.

For example, in 3 GPP LTE, how many physical antennas are included in the antenna port is not specified, but the minimum unit allowing the base station to transmit different reference signals is specified.

In addition, the antenna port may be specified as a minimum unit for multiplying a weight of the pre-coding vector.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2009-163396, filed on Jul. 10, 2009, including the specification, drawings and abstract, is incorporated herein by reference in its entirety.

### INDUSTRIAL APPLICABILITY

The terminal apparatus, the base station apparatus, the feedback method, and the retransmission control method according to the present invention can avoid a conflict of the response signal between a plurality of terminals and, for example, are useful as a terminal apparatus and the like in the mobile WiMAX.

### REFERENCE SIGNS LIST

101: PA allocation control section
102: downlink allocation control information creating section
103: RF receiver section
104: demodulation section
105: ACK/NACK/DTX determination section
106: retransmission control section
107: initial transmission/retransmission data creating section
108, 109: modulation section
110: allocation section
111: RF transmitter section
201: RF receiver section
202: demodulation section
203: control information decoding section
204: PA determination section
205: data decoding section
206: error detection section
207: response control section
208: modulation section
209: allocation section
210: RF transmitter section

1-7. (canceled)

8. A terminal apparatus comprising:
a receiver section that receives downlink allocation control information transmitted on a downlink control resource and downlink data transmitted on a downlink data resource indicated by the downlink allocation control information;
an error detection section that detects an reception error of the received downlink data;
a determination section that determines whether or not resource allocation is terminated based on the received downlink allocation control information; and
a response control section that controls a transmission of a response signal for use in retransmission control of the downlink allocation control information and the downlink data, based on the error detection result obtained from the error detection section and the determination result obtained from the determination section,
wherein the response control section transmits an ACK/NACK depending on the error detection result using a data response resource notified by the downlink allocation control information, and transmits an ACK as a response signal for the downlink allocation control information using the same resource as the data response resource when the determination section determines that the resource allocation is terminated.

9. The terminal apparatus according to claim 8,
wherein the downlink allocation control information contains information of the data response resource when the resource allocation is initiated, and contains information of the control response resource which notifies the ACK for the downlink allocation control information when the resource allocation is terminated, and
the determination section determines that the resource allocation termination is performed in the next transmission when the control response resource is different from the data response resource.

10. The terminal apparatus according to claim 8,
wherein the downlink allocation control information contains initial-transmission/retransmission information indicating whether a notification of resource allocation termination is initial transmission or retransmission, and
the response control section transmits the ACK as the response signal for the downlink allocation control information using the control response resource in a case where the initial-transmission/retransmission information indicates initial transmission, and the response control section transmits the ACK as the response signal for the downlink allocation control information using the data response resource in a case where the initial-transmission/retransmission information indicates retransmission.

11. The terminal apparatus according to claim 8,
wherein the determination section determines the control response resource based on a position of the downlink control resource.

12. A base station apparatus comprising:
a transmitter section that transmits downlink data using a downlink data resource at an event of resource allocation initiation, transmits information of the downlink data resource and downlink allocation control information containing a control response resource where an ACK/NACK depending on an error result of the downlink data is transmitted, and transmits the downlink allocation control information containing information indicating resource allocation termination at an event of resource allocation termination;
a receiver section that receives an ACK/NACK depending on an error result of the downlink data and an ACK for the downlink allocation control information on the control response resource;
a determination section that determines that the resource allocation termination is completed when the receiver section receives the ACK for the downlink allocation control information at the event of resource allocation termination and determines that the resource allocation termination is overlooked when the receiver section receives the NACK for the downlink data; and
a control section that controls retransmission of the downlink allocation control information at the event of resource allocation termination when the determination section determines that the resource allocation termination is overlooked.

13. A feedback method comprising:
receiving downlink allocation control information transmitted on a downlink control resource and downlink data transmitted on a downlink data resource indicated by the downlink allocation control information;
detecting an reception error of the received downlink data;
determining whether or not resource allocation is terminated based on the received downlink allocation control information; and
transmitting an ACK/NACK depending on a detection result of the reception error using a data response resource notified by the downlink allocation control information and transmitting an ACK as a response signal for the downlink allocation control information using the same resource as the data response resource when it is determined that the resource allocation is terminated.

14. A retransmission control method comprising:
transmitting downlink data using a downlink data resource at an event of resource allocation initiation, transmitting information of the downlink data resource and downlink allocation control information containing a control response resource where an ACK/NACK depending on an error result of the downlink data is transmitted, and transmitting the downlink allocation control information containing information indicating resource allocation termination at an event of resource allocation termination;
receiving an ACK/NACK depending on an error result of the downlink data and an ACK for the downlink allocation control information on the control response resource;
determining that the resource allocation termination is completed when the ACK for the downlink allocation control information is received at the event of resource allocation termination and determining that the resource allocation termination is overlooked when the NACK for the downlink data is received; and
controlling retransmission of the downlink allocation control information at the event of resource allocation termination when it is determined that resource allocation termination is overlooked.
